(19) United States
(12) Patent Application Publication
(10) Pub. No.: US 2012/0188329 A1
(43) Pub. Date: Jul. 26, 2012

(54) SYSTEMS FOR VERTICAL PERSPECTIVE CORRECTION

(76) Inventors: Kevin Archer, Padbury (GB); Graham Kirsch, Bramley (GB)

(21) Appl. No.: 13/082,040

(22) Filed: Apr. 7, 2011

Related U.S. Application Data
(60) Provisional application No. 61/436,503, filed on Jan. 26, 2011.

(51) Int. Cl. G06K 9/40; H04N 7/15

(52) U.S. Cl. 348/14.08; 382/254; 348/E05.073

(57) ABSTRACT

Systems are provided for vertical perspective correction during image processing. An image processor may receive an input image from an image sensor and output a lower resolution output image that may be suitable for transmission during videoconferencing. Triangular portions of an input image may be masked to produce a trapezoidal masked image. The trapezoidal masked image may be horizontally scaled using a varying horizontal scale factor. The image may be vertically scaled using a vertical scale factor.

This application claims the benefit of provisional patent application No. 61/436,503, filed Jan. 26, 2011, which is hereby incorporated by reference herein in its entirety.

### BACKGROUND

The present invention relates to image processing, and, in particular, vertical perspective correction for videoconferencing.

When videoconferencing using a camera on a cell phone or laptop computers, the subject is often not directly aligned in front of the camera. Often, the camera is positioned below the height of the subject and angled upwards. As a result, the vertical perspective of the subject can be distorted. For example, a subject's jaw might appear to be wider relative to a subject's forehead.

Vertical perspective correction can be used to correct the image during image processing. However, conventional systems for vertical perspective correction can require significant hardware resources. It can be difficult to implement conventional vertical perspective correction systems in a cost-effectively, particularly in systems such as mobile phones or portable computers

It may therefore be desirable to have improved systems for vertical perspective correction.

### BRIEF DESCRIPTION OF THE DRAWINGS

FIG. 1 is a diagram of an illustrative imaging situation that may result in a need for vertical perspective correction in accordance with an embodiment of the present invention.

FIG. 2A is a front view of an illustrative subject that may be captured by a camera in accordance with an embodiment of the present invention.

FIG. 2B is diagram of an illustrative image that may need vertical perspective correction in accordance with an embodiment of the present invention.

FIG. 3 is a diagram showing a conventional system for compressing portions of an image during vertical perspective correction.

FIG. 4 is a diagram showing a conventional system for stretching portions of an image during vertical perspective correction.

FIG. 5 is a diagram showing an illustrative imaging device having an image sensor and an image processor in accordance with an embodiment of the present invention.

FIG. 6 is a diagram showing a conventional scaler for scaling images during image processing.

FIG. 7 is a diagram showing a scaler with vertical perspective correction in accordance with an embodiment of the present invention.

FIG. 8A is a diagram showing an illustrative image that may have vertical perspective distortion arising from a camera being angled downward towards a subject in accordance with an embodiment of the present invention.

FIG. 8B is a diagram showing an illustrative trapezoidal masked image that has a bottom edge that is narrower than a top edge in accordance with an embodiment of the present invention.

FIG. 8C is a diagram showing an illustrative output image that has been downscaled from the trapezoidal masked image of FIG. 8B in accordance with an embodiment of the present invention.

FIG. 9A is a diagram showing an illustrative image that may have vertical perspective distortion arising from a camera being angled upward towards a subject in accordance with an embodiment of the present invention.

FIG. 9B is a diagram showing an illustrative trapezoidal masked image that has a top edge that is narrower than a bottom edge in accordance with an embodiment of the present invention.

FIG. 9C is a diagram showing an illustrative output image that has been downscaled from the trapezoidal masked image of FIG. 9B in accordance with an embodiment of the present invention.

FIG. 10 is a diagram showing an illustrative downscaling of an image that has been masked in accordance with an embodiment of the present invention.

### DETAILED DESCRIPTION

Vertical perspective correction may be applied to images to correct for distortion that can arise when a subject is not directly aligned with a camera. Vertical perspective correction may be useful for static images or for videoconferencing. Videoconferencing may also be known as also known as video calling or video chatting. A camera in a cellular telephone or computer may be used for videoconferencing. During videoconferencing, a camera is often not positioned so that is directly aligned with a user's face. For example, a camera might be positioned below the subject and angled upwards towards a user's face. A camera might also be positioned above a subject and angled downwards towards a user's face. In such cases, a user's face may appear distorted in the resulting image.

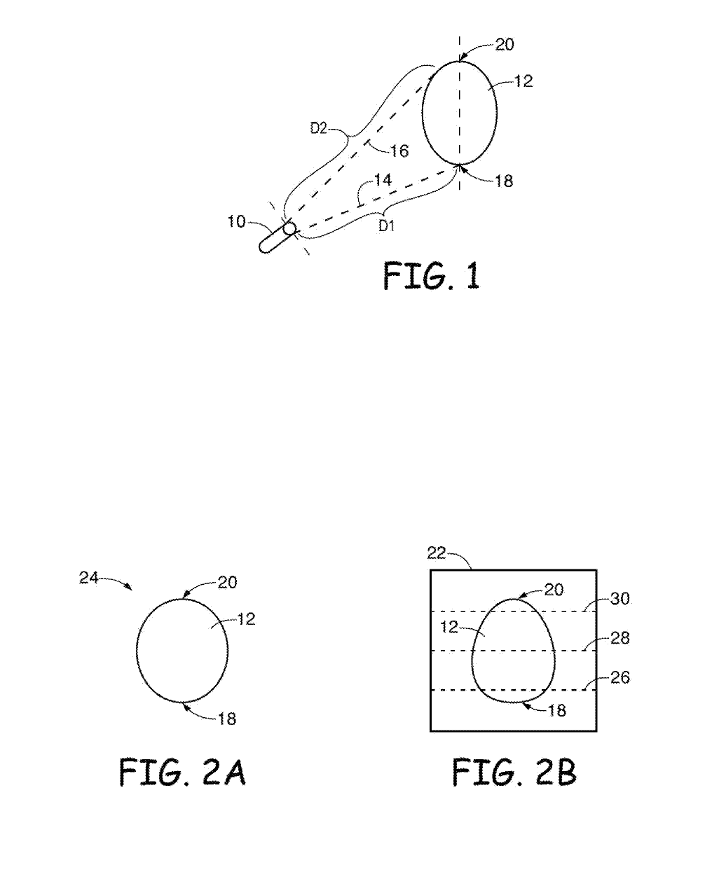

In the illustrative example of FIG. 1, camera 10 may be a camera on a mobile phone or computer. Subject 12 may be the face of a person that is videoconferencing using camera 10. In the example of FIG. 1, camera 10 may be positioned below the height of subject 12. For example, camera 10 may be in a mobile phone that is held in a user's hand at waist level or chest level. Camera 10 may be a webcam in a laptop or a webcam used with a desktop computer that is positioned at waist level or chest level.

Distance D1 between camera 10 and a lower portion 18 of subject 12 may be indicated by dashed line 14. Distance D2 between camera 10 and an upper portion 20 of subject 12 may be indicated by dashed line 16. Due to the relative positions and angles of cameral 10 and subject 12, distance D1 may be shorter than distance D2.

In a resulting image the lower portion 18 (such as a user's chin) may appear to be enlarged relative to upper portion 20 (such as the top of a user's head). FIG. 2A is a diagram showing an illustrative front view 24 of subject 12, which may be a user's face. FIG. 2B is a diagram showing an image 22 of subject 12 that may be captured by camera 10 of FIG. 1. Image 22 may be distorted. A lower portion 18 may appear to be wider relative to an upper portion 20 of subject 12. The vertical distortion may have a tendency to make objects appear trapezoidal. This type of vertical distortion may be known as a “frog view” distortion.

Similarly, if a camera is positioned above a user's face and angled downwards, a user's forehead may appear to be unnaturally wide and a user's chin may appear to be unnaturally narrow. Such a situation may arise if a camera is positioned above a screen, such as a camera in a laptop or a webcam that is placed on top of a computer screen.

The effect of vertical perspective distortion can be approximated as a keystone distortion in which each row in an image is horizontally stretched or compressed by a scale factor that varies linearly down the image.

In a conventional vertical distortion correction system, a portion of an image is horizontally compressed and another portion of an image is horizontally stretched. In the example of FIG. 2B, pixel rows at near the top of the image, such as at dashed line 30, are stretched, and pixel row near the bottom of the image, such as at dashed line 26, are compressed. A pixel row at the center of the image, such as at dashed line 28, remains unchanged. The scale factor for compressing or stretching varies linearly down the image.

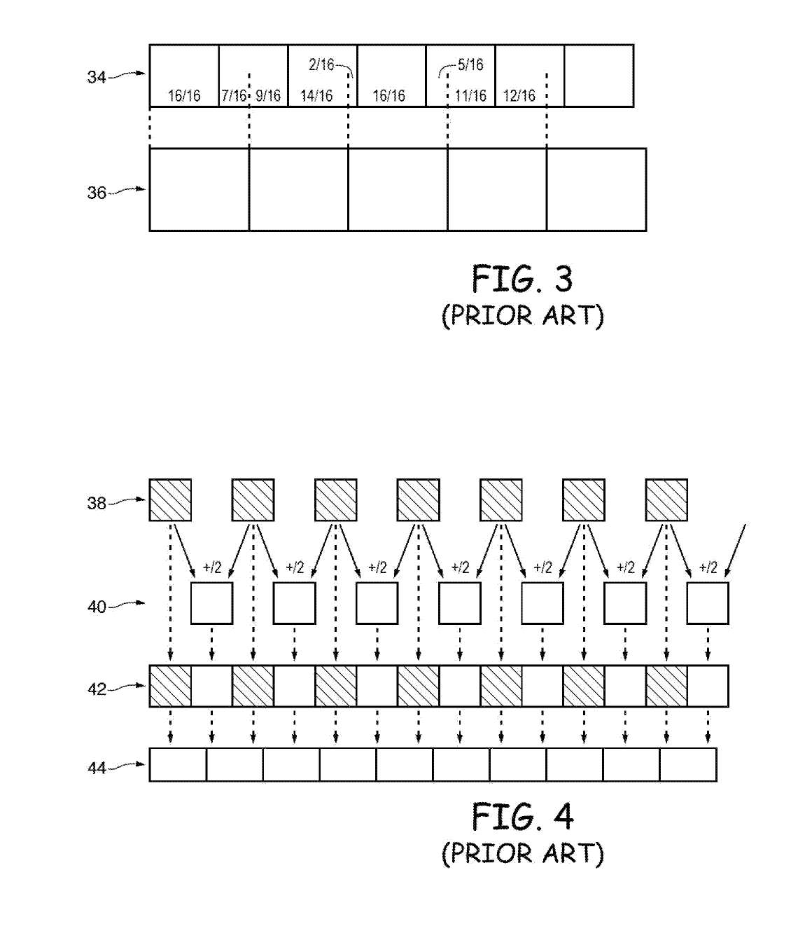

FIG. 3 is a diagram illustrating a conventional approach to compressing (downscaling) lines of pixels. Such an approach is used by a Bayer mode (SMIA) scaler. In Bayer mode (SMIA), a scaling factor is defined as an improper fraction M/N, where N is a constant 16. Each input pixel 34 in FIG. 3 is treated as 16 fractional parts. Output pixels are larger and have M fractional parts. Output pixels 36 of FIG. 3 have 23 fractional parts. Output pixels 36 overlap two or more input pixels 34. Input pixels 34 that are completely covered by an output pixel contribute 16 times their value to the accumulated total for that output pixel. Input pixels that are partially covered by output pixels are shared between the output pixels proportionately. A calculation is performed sequentially that progresses through a pixel line. A quantity called a residual is defined as the remaining portion of the current output pixel that has not yet been calculated. An initial value of the residual at the start of the line can be used to adjust the positions of the output components with respect to each other. Pixels 36 have a lower number of pixels per line than pixels 34.

FIG. 4 is a diagram illustrating a conventional approach to stretching (upscaling) lines of pixels. A linear interpolation can be used between neighboring pixels if the amount of stretching is limited to a factor of two. In the example of FIG. 4, input pixels 38 can be used to derive interpolated pixels 40. Pixels 42 form a reconstructed pixel stream. Pixels 44 form an output pixel stream. Pixels 44 have a larger number of pixels per line than pixels 38.

The conventional methods of FIG. 3 and FIG. 4 may demand certain hardware requirements that may be impractical to implement on devices such as mobile telephones and webcams. In particular, upscaling images, as in the example of FIG. 4 may require large amounts of hardware resources.

A camera on a mobile telephone that is used for videoconferencing maybe be one of two cameras on the mobile telephone. In such a situation, vertical perspective correction may need to be implemented very cost-effectively. For example, a camera that is used for videoconferencing may be a camera that is on a front face of a mobile telephone. The front face of a mobile phone may also have a screen. Such mobile phone may also have another camera on a back side of the phone.

It may be desirable to provide vertical perspective correction that is simple and cost-effective. It may be desirable to implement vertical perspective correction that efficiently makes use of existing hardware on an imaging device.

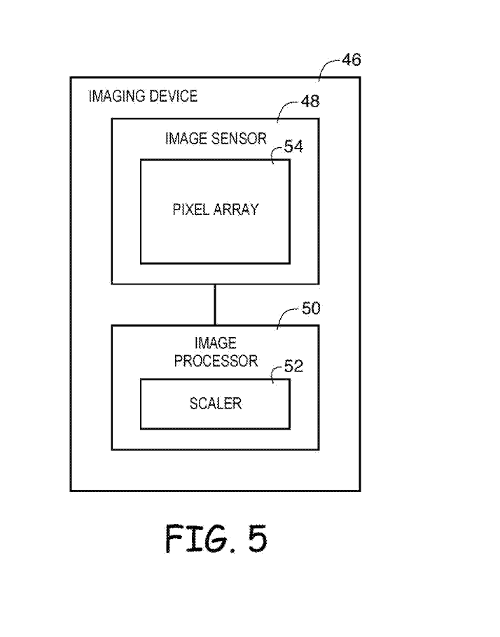

FIG. 5 is a diagram of an illustrative imaging device 46 that may be provided with vertical perspective correction. Imaging device 46 may be a camera in a mobile phone, a camera in a laptop computer, a camera in a tablet computer, a webcam that is used with a desktop computer, a stand-alone camera or videoconference equipment.

As shown in FIG. 5, imaging device 46 may have image sensor 48. Image sensor 48 may have pixel array 54. Imaging device 46 may have image processor 50 that processes images from image sensor 48. Image processor 50 may be a hardwired image processor. Image processor 50 may have a scaler such as scaler 52 that scales images from pixel array 54.

Pixel array 54 may have a resolution that is known as the native resolution of imaging device 46 and pixel array 54. During videoconference calls, video may be transmitted in an output format having a resolution that is less that the native resolution of imaging device 46. Scaler 52 in FIG. 5 may scale an image received from image sensor 48 that has the native resolution of image sensor 48 to a format having a lower resolution. Scaling that decreases resolution may be known as downscaling. The native resolution of image sensor 48 may be any suitable resolution. Scaler 52 may output an image with any suitable resolution. For example, it may be desirable to stream video in a VGA (640×480 pixels) or CIF (352×188 pixels) format. Scaler 52 may output an image in a VGA (640×480 pixels) or CIF (352×188 pixels) format. In another example, imaging sensor 48 may have a native resolution of 640×480 pixels, and scaler 52 may downscale an image from a resolution of 640×480 pixels to a resolution of 320×240 pixels.

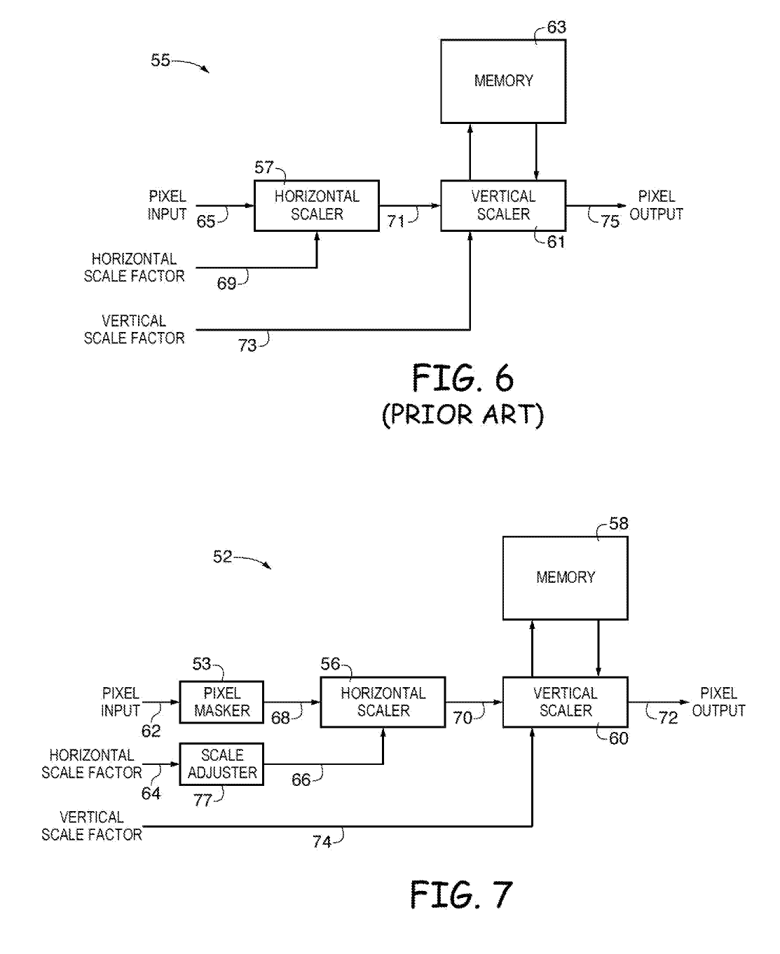

FIG. 6 is a diagram of a conventional scale such as scaler 55. Scaler 55 of FIG. 6 has horizontal scaler 57, vertical scaler 61, and memory 63. Horizontal scaler 57 receives pixel input (also known as an input image) on path 65 from an image sensor. Horizontal scaler 57 receives horizontal scale factor on path 69. Horizontal scaler 57 uses the horizontal scale factor to horizontally scale the pixel input. Vertical scaler 61 receives a horizontally scaled image on path 71 from horizontal scaler 57. Vertical scaler 61 receives a vertical scale factor on input 73. Vertical scaler 61 uses the vertical scale factor to vertically scale the image received from horizontal scaler 57. Vertical scaler 61 is connected to memory 63. Vertical scaler 61 outputs a scaled pixel output on path 75.

FIG. 7 is a diagram of an illustrative scaler having vertical perspective correction in accordance with an embodiment of the present invention. Scaler 52 of FIG. 7 may have a pixel masker such as pixel masker 53 preceding a horizontal scaler such as horizontal scaler 56. Pixel masker 53 may receive pixel input on path 62. Pixel input may also be known as an input image and may be received from an image sensor such as image sensor 48 of FIG. 5. Pixel masker 53 may output a masked image on path 68 to horizontal scaler 56. Scaler adjuster 77 may receive a horizontal scale factor on path 64 which may be a constant horizontal scale factor and output variable horizontal scale factor on path 66 to horizontal scaler 56. Horizontal scaler 56 may horizontally scale a masked image received from pixel masker 53 and output a horizontally scaled image on path 70 to vertical scaler 60. Vertical scaler 60 may receive a vertical scale factor on path 74. Vertical scaler 60 may use the vertical scale factor to vertically scale the image received from horizontal scaler 56. Vertical scaler 60 may be connected to memory 58. Vertical scaler 60 may output pixel output on path 72. Pixel output may also be known as an output image.

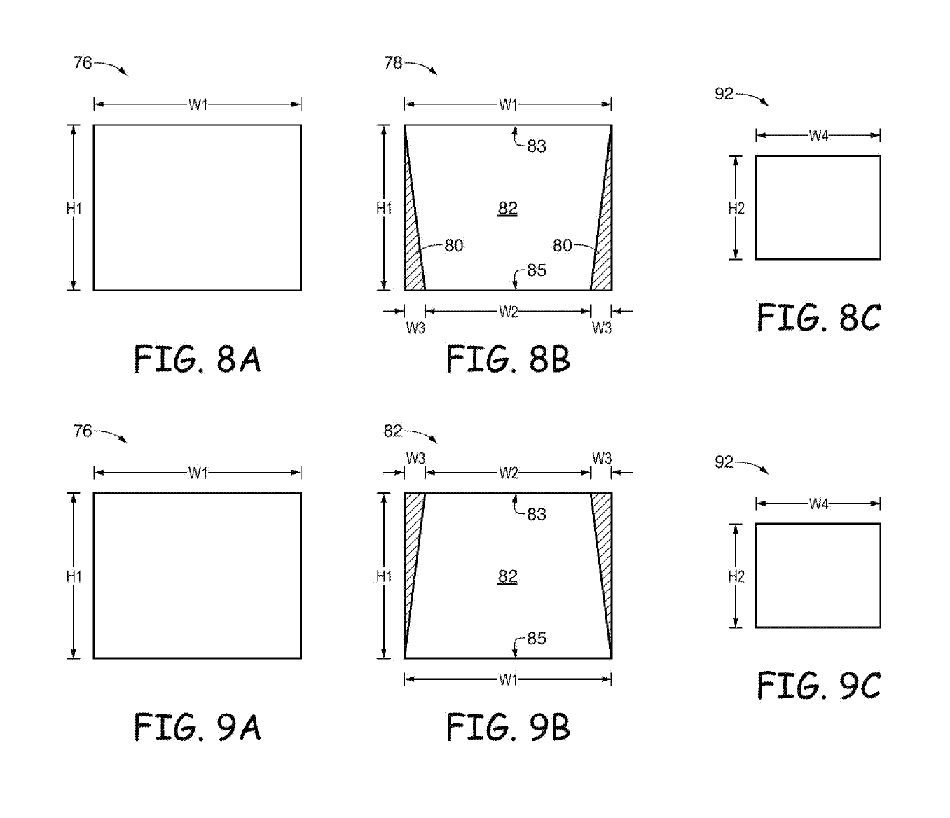

FIG. 8A is an illustrative diagram of an input image that may be received on path 62 of FIG. 7. Image 76 of FIG. 8A may have a vertical resolution (or height) H1 and a horizontal resolution (or width) W1. Image 76 may have a resolution that is the native resolution of image sensor 48 of FIG. 5. Image sensor 48 may have any suitable resolution. As an example, image 76 may have horizontal resolution of W1 of 640 pixels and a vertical resolution H1 of 480 pixels.

FIG. 8B is a diagram of an illustrative image that has been masked by pixel masker 53. Image 78 may have masked regions 80 and a trapezoidal unmasked region 82. Unmasked region 82 may have a width W1 on the top of the image and a width W2 on the bottom of the image. Unmasked region 82 has a varying number of pixels on each row. The masked regions 80 may be triangular in shape and have widths W3. The wider the masked regions 80 (i.e. the larger the widths W3), the greater the vertical perspective correction of the final image. As an example, if width W1 is 640 pixels and height H1 is 480 pixels, width W2 of image 78 may be 576 pixels. Each masked region 80 may have a width W3 of 32 pixels.

Unmasked region 82 may also be known as a masked image—i.e. an image that has been produced by pixel masker 53 of FIG. 7. Masked image 82 may have a trapezoidal shape that is wider along a top edge such as top edge 82 and narrower along a bottom edge such as bottom edge 85. The trapezoidal shape of masked image 82 may be suitable for a situation in which a camera is positioned above a subject's face and angled downwards—for example if a camera is mounted in screen above the center of a subject's face.

FIG. 8C is an illustrative image 92 has been horizontally scaled by horizontal scaler 56 and vertically scaled by vertical scaler 60. Image 92 may have a width W4 that is less than widths W1 and W2 of image 82 in FIG. 8B. Image 92 may have a height H2 that is less than height H1 of image 82. As an example, if width W1 is 640 pixels and height H1 is 480 pixels, width W4 may be 320 pixels and height H2 may be 240 pixels. When image 92 is scaled from image 82, a varying horizontal scale factor is used so that the top portion of image 82 is compressed more than the bottom portion of image 82. Image 92 has also been scaled so that it has the same number of pixels on each line.

In the examples of FIG. 8A-8C, vertical perspective correction is provided for a case such as when a camera is positioned above a subject's face and angled downwards. In such a situation, a subject's forehead might appear to be unnaturally wide as compared to a subject's chin. When trapezoidal image 82 is scaled to produce image 92, the top portion of image 82 (e.g., regions of image 82 closer to top edge 83), which may show a subject's forehead, may be compressed more than a bottom portion of image 82 (e.g., regions of image 82 closer to bottom edge 85), which may show a subject's chin.

In the example of FIGS. 9A-9C, trapezoidal image 82 of FIG. 9B is narrower on a top edge 83 than on a bottom edge 85. The example of FIG. 9B may be suitable for a case where a camera is positioned below and angled upwards towards a subject's face. In such a situation, a subject's chin may appear to be unnaturally wide and a subject's forehead may appear to be unnaturally narrow. Trapezoidal image 82 of FIG. 9B may have a bottom edge 85 that is compressed relative to a top edge 83 when trapezoidal image 82 is scaled to form image 92 of FIG. 9C.

The degree of vertical correction that is desired may depend on how a camera is positioned relative to a subject. If the camera is in a handheld device such as a mobile phone, the degree of needed vertical correction may vary from session to session of videoconferencing. If the camera is not resting on a stable surface—for example if it is being held in a user's hand—the degree of vertical correction that is needed may vary during a single videoconferencing session. A camera may be positioned above a subject's face in one session and need vertical perspective correction as shown in FIGS. 8A-8C and may be positioned below a subject's face in another session and need vertical perspective correction as shown in FIGS. 9A-9C.

The amount of vertical perspective correction may be adjustable. For example, an interface may be provided for the user, and the user may manually adjust the amount of vertical perspective correction. The user may perform adjustments before the videoconference or in real-time during the videoconference. Automatic vertical perspective correction may also be provided. Imaging device 46 of FIG. 5 may automatically determine the amount of vertical perspective that is needed. If desired, imaging device 46 may analyze an image of a user to determine the amount of vertical perspective correction that is needed. Imaging device 46 may also determine the needed amount of vertical perspective correction from an orientation of imaging device 46 or by other suitable methods.

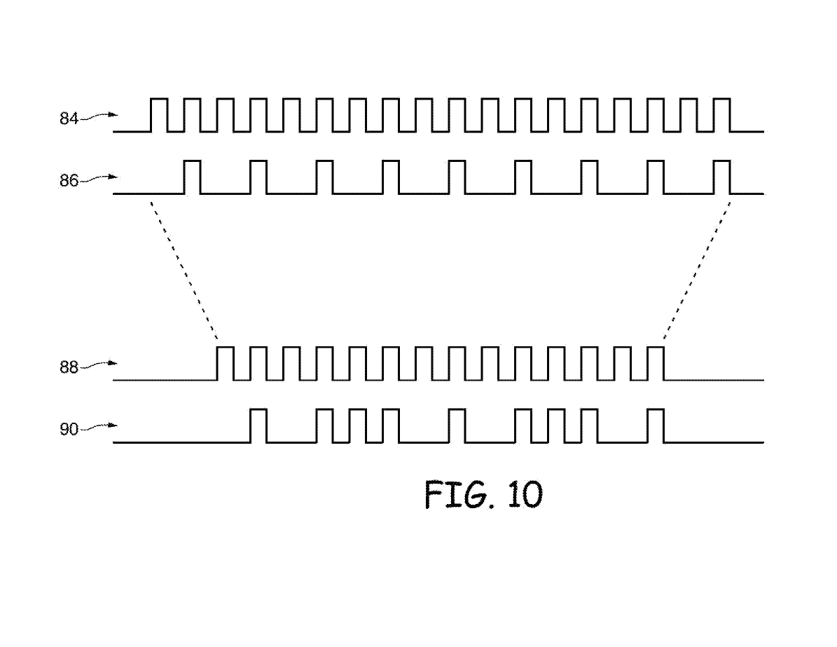

FIG. 10 is a diagram of pixel scaling that may correspond to the vertical perspective correction of FIGS. 8A-8C. Pixels 84 may represent pixels at the top line of trapezoidal image 82 of FIG. 8B. For example, pixels 84 may represent pixels for a 640 pixel line if a width W1 of image 82 is 640 pixels. Pixels 86 may represent pixels at a top line of scaled image 92 of FIG. 8C. Pixels 86 may represent pixels for a 320 pixel line. In the example of FIG. 10, there is a 2 to 1 correspondence between pixels 84 and pixels 86.

Pixels 88 may represent pixels at a bottom line of trapezoidal image 82. Pixels 88 have fewer pixels per line as compared to pixels 84 because trapezoidal image 82 has been masked. Pixels 88 may have the same spacing as pixels on pixel line 84. Pixels 90 may represent pixels in a bottom line of scaled image 92 of FIG. 8C. Pixel line 90 may have the same number of pixels as pixel line 86.

While trapezoidal image 82 of FIG. 8B may have constant pixel timings, output image 92 of FIG. 8C may have timings that vary slightly on a per row basis.

In the vertical perspective correction processes of FIGS. 5, 7, 8A-8C, 9A-9C, and 10, input images have been masked and compressed to produce a vertical perspective corrected output image. No portions of the input images are stretched (upscaled). Stretching images (such as in the conventional method of FIG. 4) can require significant hardware resources. In addition, the vertical perspective correction processes of FIGS. 5, 7, 8A-8C, 9A-9C, and 10 may take advantage of image processing hardware that may have already been available on a device that is configured for videoconferencing. Vertical perspective correction may utilize scalers that provide downscaling functions for downscaling video for transmission.

Various embodiments have been described illustrating imaging processing systems for vertical perspective correction.

An image processor is provided that performs vertical perspective correction. The image processor may receive an input image from an image sensor and output a lower resolution image that may be suitable for transmission during videoconferencing.

An image processor may have a pixel masker that masks triangular portions of an input image. The remaining unmasked portion of the image may have a trapezoidal shape. The trapezoidal image may be wider at the top of the image and narrower at the bottom of the image. If desired, the trapezoidal image may be narrower at the top of the image and wider at the bottom of image.

An image processor may have a horizontal scaler that that receives the trapezoidal image. The horizontal scaler may scale the image horizontally to reduce the resolution of the image in the horizontal direction. The horizontal scaler may scale the trapezoidal image to produce a rectangular image. The horizontal scaler may receive a varying horizontal scale factor. During the scaling, the wider portions of the trapezoidal image may be compressed more than the narrower portions of the trapezoidal image.

A vertical scaler may receive an image from the horizontal scaler. The vertical scaler may scale the image to reduce the resolution in the vertical direction. The vertical scaler may output an output image that has a lower resolution than the input image received from the image sensor. The output image may have a top portion that is compressed relative to a bottom portion.

The foregoing is merely illustrative of the principles of this invention which can be practiced in other embodiments.

What is claimed is:

1. A method for correcting vertical perspective with an image processor, comprising:
at the image processor, receiving a first image;
at the image processor, masking the input image to produce a second image having a trapezoidal shape; and
at the image processor, downscaling the second image to produce an output image, wherein the output image has a rectangular shape.

2. The method defined in claim 1, wherein masking the input image to produce the second image having a trapezoidal shape comprises masking triangular portions of the input image.

3. The method defined in claim 1, wherein the second image has a bottom edge and a top edge, wherein the bottom edge is narrower than the top edge, wherein masking the input image to produce the second image having a trapezoidal shape comprises masking triangular portions of the input image.

4. The method defined in claim 1, wherein the second image has a bottom edge and a top edge, wherein the bottom edge is wider than the top edge, wherein masking the input image to produce the second image having a trapezoidal shape comprises masking triangular portions of the input image.

5. The method defined in claim 1, wherein downscaling the second image to produce an output image comprises:
using a varying horizontal scale factor to horizontally downscale the second image.

6. The method defined in claim 1, wherein downscaling the second image to produce an output image comprises:
using a varying horizontal scale factor to horizontally downscale the second image to produce a horizontally-scaled image, wherein the output image has a horizontal resolution that is less than a horizontal resolution of the first image and wherein the varying horizontal scale factor varies linearly from a top edge of the second image to a bottom edge of the second image.

7. The method defined in claim 6, wherein downscaling the second image to produce an output image further comprises:
vertically downscaling the horizontally scaled image.

8. A method for performing vertical perspective correction, comprising:
masking an input image to produce a trapezoidal masked image; and
downscaling the trapezoidal masked image.

9. The method defined in claim 8, wherein downscaling the trapezoidal masked image comprises:
horizontally downscaling the trapezoidal image; and
vertically downscaling the trapezoidal image.

10. The method defined in claim 9, further comprising streaming the output image during videoconferencing.

11. The method defined in claim 10, further comprising receiving an input image from an image sensor on a cellular telephone.

12. The method defined in claim 10, further comprising receiving an input image from an image sensor on a webcam.

13. The method defined in claim 9, wherein downscaling the trapezoidal masked image comprises downscaling with a horizontal scaler that receives a varying horizontal scale factor.

14. An imaging device, comprising:
an image sensor; and
an image processor that receives input images from the image sensor, wherein the image processor performs vertical perspective correction during videoconferencing to produce output images that have resolutions that are lower than resolutions of the input images.

15. The imaging device defined in claim 14, wherein the image processor further comprises:
a pixel masker; and
a horizontal scaler that receives masked images from the pixel masker.

16. The imaging device defined in claim 15, wherein the horizontal scaler receives a varying horizontal scale factor.

17. The imaging device defined in claim 16, further comprising a vertical scaler that receives a horizontally-scaled image from the horizontal scaler.

18. The imaging device defined in claim 17, further comprising a scale adjuster, wherein the scale adjuster receives a constant horizontal scale factor and outputs a varying horizontal scale factor.

19. The imaging device defined in claim 14, wherein the image sensor comprises:
a pixel masker;
a horizontal scaler that receives masked images from the pixel masker and downscales the masked image to produce horizontally-scaled images; and
a vertical scaler that receives the horizontally-scaled images and downscales the horizontally scaled images to produce the output images.

20. The imaging device defined in claim 1, wherein the image device comprises a cellular telephone.
